(19) United States
(12) Patent Application Publication
(10) Pub. No.: US 2003/0225858 A1
(43) Pub. Date: Dec. 4, 2003

(54) Method and apparatus for traversing Web pages in a network data processing system

(75) Inventors: Susann Marie Keohane, Austin, TX (US); Gerald Francis McBrearty, Austin, TX (US); Shawn Patrick Mullen, Buda, TX (US); Jessica Kelley Murillo, Hutto, TX (US); Johnny Meng-Han Shieh, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY (US)

(21) Appl. No.: 10/159,510

(22) Filed: May 30, 2002

(51) Int. Cl. G06F 15/16

(52) U.S. Cl. 709/218; 709/203

(57) ABSTRACT

A method, apparatus, and computer instructions for traversing Web pages. A referring link is identified to form an identified referring link in response to receiving a request for an anchor point in a particular Web page. The referring link is stored in association with the anchor point to form a set of referring links to the anchor point on the particular Web page. At least one of the set of referring links is sent to a requesting client.

### BACKGROUND OF THE INVENTION

1. Technical Field

The present invention relates generally to an improved data processing system, and in particular, to a method and apparatus for retrieving resources. Still more particularly, the present invention provides a method and apparatus for traversing Web pages in a network data processing system.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

One of the useful properties of Web pages is the property that allows Web page authors an ability to point to the same reference point in a Web page from multiple source points and allow a user to return to a source point. With respect to HTML code, the source point is the point in a Web page that may be selected by a user and is referred to as the “link”. The target point is the point in a Web page to which the user is taken when the source point is selected and is called the “anchor”. The source point and the target point may be located in the same Web page or in different Web pages.

Often times, a user may follow a link in a parent Web page to an anchor in a child Web page and wonder what other links or pages also may refer to the same anchor position in a child Web page. Currently, the only process for identifying other links to the anchor point involves continuing to read the same source Web page and to check the target anchor points of other links in that page. Such a process can be tedious and slow. Further, this process does not tell the user whether other parent pages include links to the anchor point in the child page.

Therefore, it would be advantageous to have an improved method, apparatus, and computer instructions for traversing Web pages in a network data processing system.

### SUMMARY OF THE INVENTION

The present invention provides a method, apparatus, and computer instructions for traversing Web pages. A referring link is identified to form an identified referring link in response to receiving a request for an anchor point in a particular Web page. The referring link is stored in association with the anchor point to form a set of referring links to the anchor point on the particular Web page. At least one of the set of referring links is sent to a requesting client.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIG. 4 is a diagram illustrating components used in traversing back to different parent pages or links from a child page in accordance with a preferred embodiment of the present invention;

FIG. 5 is a diagram illustrating links in an anchor in accordance with a preferred embodiment of the present invention;

FIG. 6 is a diagram illustrating a graphical user interface for traversing Web pages in accordance with a preferred embodiment of the present invention;

FIG. 7 is a flowchart of a process used for saving links in a reference cache in accordance with a preferred embodiment of the present invention;

FIG. 8 is a flowchart of a process used for sending links to a client in accordance with a preferred embodiment of the present invention; and

FIG. 9 is a flowchart of a process used for traversing Web pages in accordance with a preferred embodiment of the present invention.

### DETAILED DESCRIPTION OF THE PREFERRED EMBODIMENT

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. These clients 108, 110, and 112 may be, for example, personal computers or network computers. In the depicted example, server 104 provides data, such as Web pages, applications, and multimedia files to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

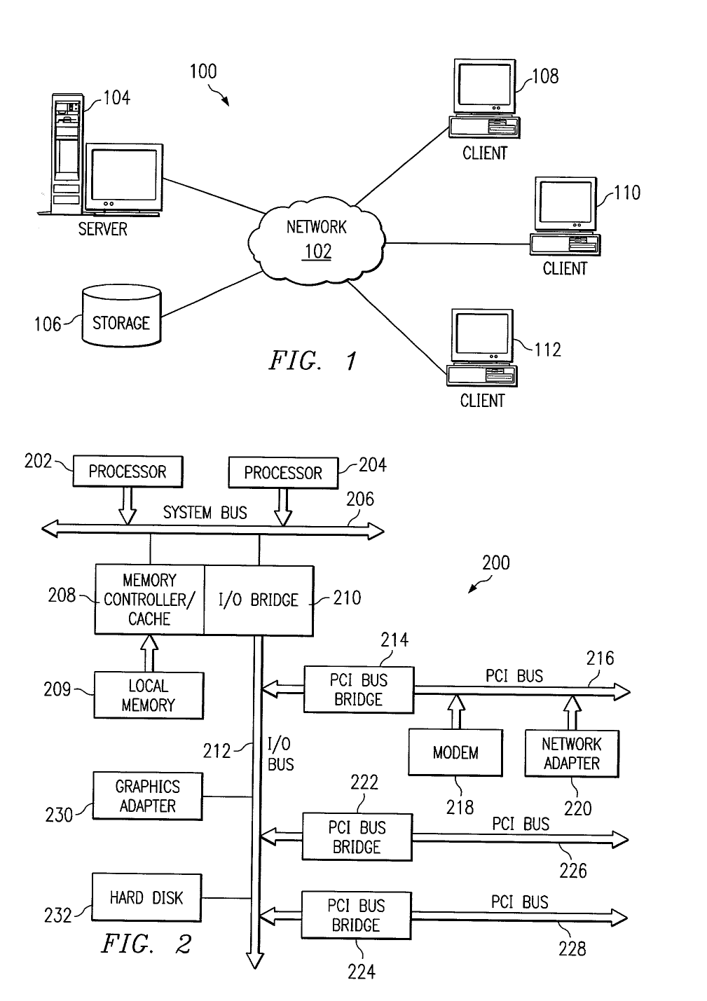

Referring to FIG. 2, a block diagram of a data processing system that may be implemented as a server, such as server 104 in FIG. 1, is depicted in accordance with a preferred embodiment of the present invention. Specifically, data processing system 200 may serve as a Web server.

Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

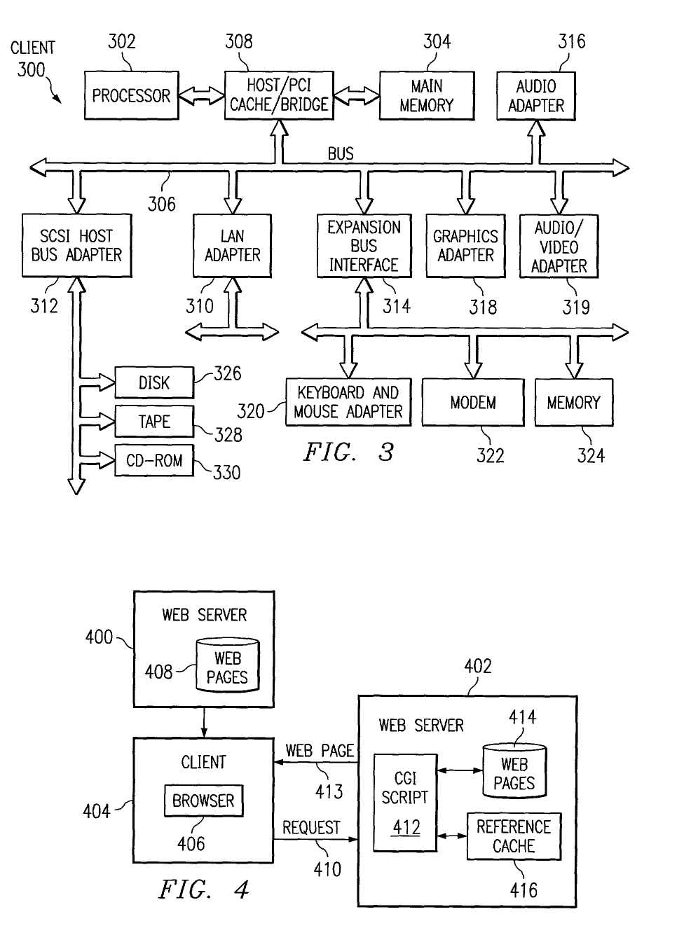

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent nonvolatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces. As a further example, data processing system 300 may be a personal digital assistant (PDA) device, which is configured with ROM and/or flash ROM in order to provide nonvolatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

With reference now to FIG. 4, a diagram illustrating components used in traversing back to different parent pages or links from a child page is depicted in accordance with a preferred embodiment of the present invention. In this example, Web server 400 and Web server 402 may be implemented using data processing system 200 in FIG. 2. Client 404 may be implemented using data processing system 300 in FIG. 3.

In this example, client 404 includes browser 406, which displays a parent Web page. This parent Web page may be obtained from Web server 400, which serves Web pages from Web pages database 408 in response to user requests. Selection of a link in the parent Web page may result in retrieval of a child Web page from Web server 402. Specifically, selection of the link in the parent Web page results in request 410 being sent to an HTTP daemon on a server, which can then pass the request onto a common gateway interface (CGI) script 412. A daemon is a UNIX program that executes in the background ready to perform an operation when required. Functioning like an extension to the operating system, a daemon is usually an unattended process that is initiated at startup. Most requests for serving of pages are handled by an HTTP daemon. However, for special processing, as disclosed in the present invention, a CGI script and process the typical request and enact special algorithms. A CGI script is a compact program written in a language such as Perl, Tcl, C or C++ that functions as the glue between HTML pages and other programs on the Web server. CGI script 412 retrieves child Web page 413 from Web pages database 414 and returns this Web page to browser 406 for display.

This returned child Web page, Web page 413, is displayed at the anchor point within this page. CGI script 412 saves the referring link from the parent Web page in reference cache 416 for use in allowing a user to jump back to other source links, which may point to an anchor point. Thus, each time any Web page refers to the anchor point in the child Web page, the link in the page is stored in reference cache 416 by the CGI script 412. This information may be returned to the user to allow the user to see other Web pages or other anchor points on the parent Web page that have the child anchor point as the target.

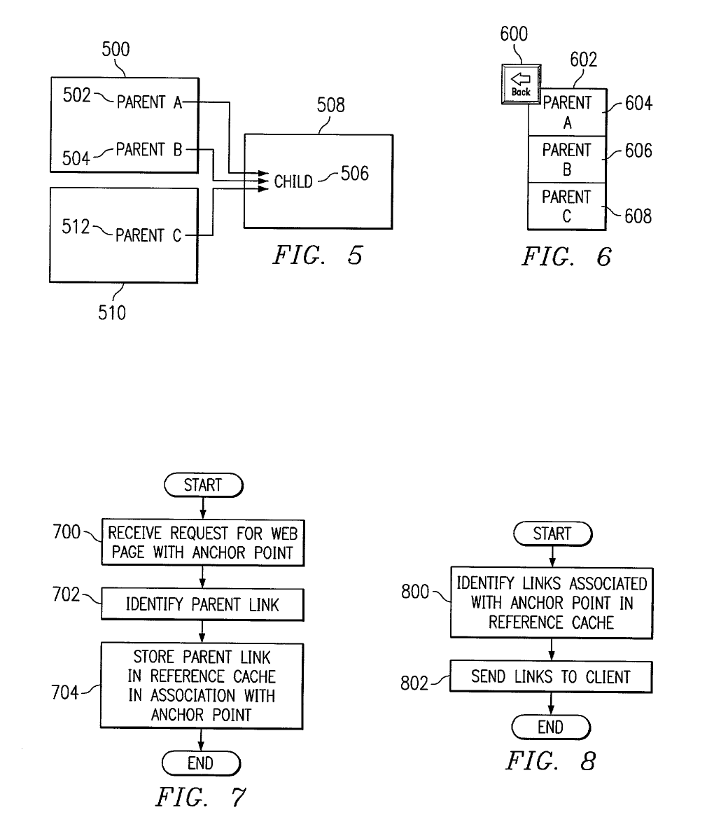

Turning next to FIG. 5, a diagram illustrating links in an anchor is depicted in accordance with a preferred embodiment of the present invention. In this example, Web page 500 represents the parent Web page and includes parent A link 502 and parent B link 504, which both point to child anchor point 506 in Web page 508, which represents the child Web page. Web page 510 includes parent C link 512, which also points to child anchor point 506.

Selection of parent A link 502 results in Web page 508 being returned and displayed at child anchor point 506. Further, parent A link 502 is stored in a reference cache, such as reference cache 416, in association with child anchor point 506. Later, if the user selects parent B link 504, Web page 508 is displayed at child anchor point 506. Parent B link 504 is also stored in association with child anchor point 506 in the reference cache.

At some other point in time, the same user or a different user may select parent C link 512 in Web page 510, which also points to child anchor point 506 in Web page 508. This selection results in Web page 508 being displayed in the browser at child anchor point 506. In addition, parent C link 512 also is stored in the reference cache in association with child anchor point 506. This process of storing links in association with anchor points is embodied in CGI script 412 in these examples. Of course, other processes may be used to store these links depending on the particular implementation, such as a servlet or a Java script program. In this manner, the number of distinct links stored increases as users traverse to child anchor point 506 in Web page 508 from different pages. Duplicate links, from previous common visitors, are not stored to save cache storage space.

Additionally, the mechanism of the present invention may include employing a browser to scan the HTML source for Web page 500 for other references to child anchor point 506 when parent A link 502 is selected. In this example, parent B link 504 would be the other link identified in the scan. Any additional references pointing to the same anchor point are sent to the Web server on which the Web page containing the anchor point is located. In this manner, a user may be able to identify other links in the Web page that point to child anchor point 506 without the user or any other user having selected that link. This feature would require that the scanning process be implemented within the browser on the client or as a plug-in or auxiliary program working with the browser. If implemented on the client side, reference cache 416 may be located on the client. Such an implementation, however, would only track links to anchor points to pages actually received by the browser.

Alternatively, the HTML source could be retrieved and scanned from the Web server originating the parent Web page. This scanning procedure would require that the security allow for the process from the Web server, such as CGI script 412, to obtain the HTML source.

Turning now to FIG. 6, a diagram illustrating a graphical user interface for traversing Web pages is depicted in accordance with a preferred embodiment of the present invention. The information regarding the different links may be returned to the browser for display to a user. One of these links may be selected to display a Web page at the location of the link, which refers to the child anchor point.

In this example, back button 600 is a button displayed in a Web browser, such as browser 406 in FIG. 4. Back button 600 may be selected and held to display menu 602. In this example, menu 602 displays links 604, 606, and 608, which correspond to parent A link 502, parent B link 504, and parent C link 512, in FIG. 5. Selection of one of these links results in the Web page being displayed at the location in which the link is located in that Web page.

For example, selection of link 606 would result in Web page 500 in FIG. 5 being displayed at the location of parent B link 504 in that Web page. Selection of link 608 would result in the display of Web page 510 at the location of parent C link 512 in FIG. 5. Further, if the user wishes to browse the different pages at a later time, these links may be saved as favorites or bookmarks by the browser. Such a saving of the links may be initiated through some selected user input, such as the pressing of a button on a pointing device.

This menu system is merely an example of one mechanism in which a user may traverse Web pages and is not meant as a limitation on the manner in which links may be presented and selected by the user. For example, a separate button may be employed for displaying menu 602. Alternatively, menu 602 may be displayed by the selection of a button on a pointing device.

Turning now to FIG. 7, a flowchart of a process used for saving links in a reference cache is depicted in accordance with a preferred embodiment of the present invention. The process illustrated in FIG. 7 may be implemented in a server process, such as CGI script 412 in FIG. 4.

The process begins by receiving a request for a Web page with an anchor point (step 700). The parent link is identified (step 702). In this example, information is transferred from the client browser to the web page server. The information that is passed from the client to the server can be, for example: (a) the name or URL of the anchor page that the client browser wishes to display; (b) the link page or URL of the parent page that references the child page; and (c) the title of the parent page that references the child page. The parent link is stored in the reference cache in association with the anchor point (step 704) and the process terminates thereafter.

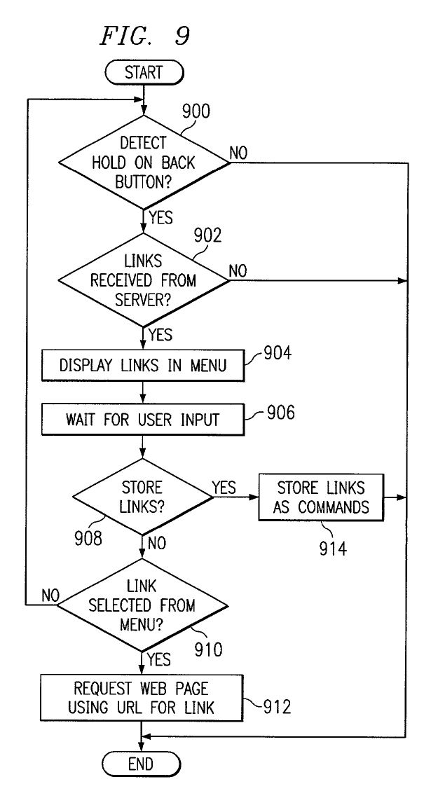

With reference now to FIG. 8, a flowchart of a process used for sending cached reference links to a client is depicted in accordance with a preferred embodiment of the present invention. The process illustrated in FIG. 8 may be implemented in a server process, such as CGI script 412 in FIG. 4.

The process begins by identifying links associated with an anchor point in the reference cache (step 800). These links are identified using a reference cache, such as reference cache 416, in FIG. 4. The anchor point may be used as an index into the reference cache. The links are sent to the client (step 802) with the process terminating thereafter.

Turning now to FIG. 9, a flowchart of a process used for traversing Web pages is depicted in accordance with a preferred embodiment of the present invention. The process illustrated in FIG. 9 may be implemented in a client, such as client 404 in FIG. 4. Specifically, this process may be implemented in a browser on the client, such as browser 406, in FIG. 4. The process also could be implemented in other ways, such as in a plug-in or a program in communication with the browser.

The process begins by making a determination as to whether a hold has been detected on the back button (step 900). A hold is a selection of the back button without the back button being released for more than some selected period of time. In this example, the control used is a back button, such as back button 600 in FIG. 6. Of course, other types of controls or mechanisms used to present selections or menus may be employed depending on the particular implementation.

If a hold is detected on the back button, a determination is made as to whether links have been received from the server (step 902). These links may have been received as a push from the server or as a pull in response to a request made to the server. If links have been received, the links are displayed in the menu (step 904). The process waits for a user input (step 906).

Next, upon receipt of a user input, a determination is made as to whether links are to be stored (step 908). If links are not to be stored, a determination is made as to whether a link is selected from a menu (step 910). If a link is selected from a menu, a Web page is requested using the URL for the link (step 912) and the process terminates thereafter. Step 912 results in the Web page being displayed at the location of the link.

Returning again to step 910, if a link is not selected from a menu, the process returns to step 900 as described above. With reference again to step 908, if the links are to be stored, the links are stored as commands (step 914) and the process terminates. Referring again to step 902, if links are not received from the server, the process terminates. With reference again to step 900, if a hold has not been detected on the back button, the process terminates.

Thus, the present invention provides an improved method, apparatus, and computer instructions for traversing Web pages. Specifically, the mechanism of the present invention allows a user to go to links on the same Web page or on other Web pages that refer to a particular anchor point. In a preferred embodiment of the present invention, a links is saved in a reference cache in association with the anchor point each time a new, distinct request is made for the anchor point. As a result, a user may be able to retrieve and visit locations in other Web pages that have not been previously viewed by the user through the information stored in the reference cache.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for traversing Web pages, the method comprising:
responsive to receiving a request for an anchor point in a particular Web page, identifying a referring link to form an identified referring link;
storing the referring link in association with the anchor point to form a set of referring links to the anchor point on the particular Web page; and
sending at least one of the set of referring links to a requesting client.

2. The method of claim 1, wherein the set of links are stored in a reference cache.

3. The method of claim 1, wherein the data processing system includes a Web server.

4. A method in a data processing system for traversing resources, the method comprising:
receiving a request for a resource;
responsive to receiving the request, identifying an originating resource;
storing a pointer to the originating resource in association with the resource to form a set of pointers for resources referring to the resource.

5. The method of claim 4 further comprising:
presenting a set of pointers to originating resources associated with the resource.

6. The method of claim 5, wherein the presenting step is initiated in response to a user request for the set of originating resources.

7. The method of claim 6, wherein the presenting step comprises:
sending the set of pointers to originating resources to a client sending the user request.

8. The method of claim 4, wherein the set of pointers are a set of addresses to servers on which the originating resources are located.

9. The method of claim 4, wherein the set of pointers is a set of universal resource locators.

10. The method of claim 4, wherein the resource and the originating resource are at least of one of Web pages, video files, and programs.

11. The method of claim 4, wherein the request includes an anchor point in the resource.

12. The method of claim 11, wherein the pointer is stored in association with the anchor point.

13. The method of claim 4, wherein the pointer is stored in a reference cache.

14. A method in a data processing system for traversing Web pages, the method comprising:
responsive to a first user input selecting a link on a first Web page, retrieving a second Web page identified by the link;
displaying the second Web page;
responsive to a second user input, identifying whether a set of referring links associated with the second Web page are available, wherein the set of referring links are links in Web pages referring to the second Web page; and
responsive to the set of links being available, displaying the set of links.

15. The method of claim 14 further comprising:
responsive to a third user input and the set of links being available, storing the set of links as a set of bookmarks.

16. The method of claim 14 further comprising:
responsive to a third user input selecting a link from the set of links being displayed, retrieving a Web page associated with the link.

17. The method of claim 14, wherein the set of referring links are located in a reference cache in the data processing system.

18. A data processing system for traversing Web pages, the data processing system comprising:
a bus system;
a communications unit connected to the bus system;
a memory connected to the bus system, wherein the memory includes a set of instructions; and
a processing unit connected to the bus system, wherein the processing unit executes the set of instructions to identify a referring link to form an identified referring link in response to receiving a request for an anchor point in a particular Web page; store the referring link in association with the anchor point to form a set of referring links to the anchor point on the particular Web page; and send at least one of the set of referring links to a requesting client.

19. A data processing system for traversing resources, the data processing system comprising:
a bus system;
a communications unit connected to the bus system;
a memory connected to the bus system, wherein the memory includes a set of instructions; and
a processing unit connected to the bus system, wherein the processing unit executes the set of instructions to receive a request for a resource; identify an originating resource in response to receiving the request; and store a pointer to the originating resource in association with the resource to form a set of pointers for resources referring to the resource.

20. A data processing system for traversing Web pages, the data processing system comprising:
a bus system;
a communications unit connected to the bus system;
a memory connected to the bus system, wherein the memory includes a set of instructions; and
a processing unit connected to the bus system, wherein the processing unit executes the set of instructions to retrieve a second Web page identified by the link in response to a first user input selecting a link on a first Web page; display the second Web page; identify whether a set of referring links associated with the second Web page are available in which the set of referring links are links in Web pages referring to the second Web page in response to a second user input; and display the set of links in response to the set of links being available.

21. A data processing system for traversing Web pages, the data processing system comprising:
identifying means, responsive to receiving a request for an anchor point in a particular Web page, for identifying a referring link to form an identified referring link;
storing means for storing the referring link in association with the anchor point to form a set of referring links to the anchor point on the particular Web page; and
sending means for sending at least one of the set of referring links to a requesting client.

22. The data processing system of claim 21, wherein the set of links are stored in a reference cache.

23. The data processing system of claim 21, wherein the data processing system includes a Web server.

24. A data processing system for traversing resources, the data processing system comprising:
receiving means for receiving a request for a resource;
identifying means, responsive to receiving the request, for identifying an originating resource;
storing means for storing a pointer to the originating resource in association with the resource to form a set of pointers for resources referring to the resource.

25. The data processing system of claim 24 further comprising:
presenting means for presenting a set of pointers to originating resources associated with the resource.

26. The data processing system of claim 25, wherein the presenting means is initiated in response to a user request for the set of originating resources.

27. The data processing system of claim 26, wherein the presenting means comprises:
sending means for sending the set of pointers to originating resources to a client sending the user request.

28. The data processing system of claim 24, wherein the set of pointers are a set of addresses to servers on which the originating resources are located.

29. The data processing system of claim 24, wherein the set of pointers is a set of universal resource locators.

30. The data processing system of claim 24, wherein the resource and the originating resource are at least of one of Web pages, video files, and programs.

31. The data processing system of claim 24, wherein the request includes an anchor point in the resource.

32. The data processing system of claim 31, wherein the pointer is stored in association with the anchor point.

33. The data processing system of claim 24, wherein the pointer is stored in a reference cache.

34. A data processing system for traversing Web pages, the data processing system comprising:
retrieving means, responsive to a first user input selecting a link on a first Web page, for retrieving a second Web page identified by the link;
displaying means for displaying the second Web page;
identifying means, responsive to a second user input, for identifying whether a set of referring links associated with the second Web page are available, wherein the set of referring links are links in Web pages referring to the second Web page; and
displaying means, responsive to the set of links being available, for displaying the set of links.

35. The data processing system of claim 34 further comprising:
storing means, responsive to a third user input and the set of links being available, for storing the set of links as a set of bookmarks.

36. The data processing system of claim 34, wherein the retrieving means is a first retrieving means and further comprising:
second retrieving means, responsive to a third user input selecting a link from the set of links being displayed, for retrieving a Web page associated with the link.

37. The data processing system of claim 34, wherein the set of referring links are located in a reference cache in the data processing system.

38. A computer program product in a computer readable medium for traversing Web pages, the computer program product comprising:
first instructions, responsive to receiving a request for an anchor point in a particular Web page, for identifying a referring link to form an identified referring link;
second instructions for storing the referring link in association with the anchor point to form a set of referring links to the anchor point on the particular Web page; and
third instructions for sending at least one of the set of referring links to a requesting client.

39. A computer program product in a computer readable medium for traversing resources, the computer program product comprising:
first instructions for receiving a request for a resource;
second instructions, responsive to receiving the request, for identifying an originating resource;
third instructions for storing a pointer to the originating resource in association with the resource to form a set of pointers for resources referring to the resource.

40. A computer program product in a computer readable medium for traversing Web pages, the computer program product comprising:
first instructions, responsive to a first user input selecting a link on a first Web page, for retrieving a second Web page identified by the link;
second instructions for displaying the second Web page;
third instructions, responsive to a second user input, for identifying whether a set of referring links associated with the second Web page are available, wherein the set of referring links are links in Web pages referring to the second Web page; and
fourth instructions, responsive to the set of links being available, for displaying the set of links.
